(19) United States
(12) Patent Application Publication
(10) Pub. No.: US 2026/0342390 A1
(43) Pub. Date: Oct. 29, 2026

(54) METHOD AND APPARATUS FOR BEAMFORMING CONTROL BASED ON COMMUNICATION PERFORMANCE METRICS

(71) Applicant: ELECTRONICS AND TELECOMMUNICATIONS RESEARCH INSTITUTE, Daejeon (KR)

(72) Inventors: Minkyeong JEONG, Seoul (KR); Kwangmyeong YANG, Seoul (KR); Jieun YU, Seoul (KR); Chungyong LEE, Seoul (KR); Dukhyun YOU, Daejeon (KR); Hoondong NOH, Daejeon (KR)

(73) Assignee: ELECTRONICS AND TELECOMMUNICATIONS RESEARCH INSTITUTE, Daejeon (KR)

(21) Appl. No.: 19/656,895

(22) Filed: Apr. 23, 2026

(30) Foreign Application Priority Data
Apr. 24, 2025 (KR) 10-2025-0053726
Apr. 21, 2026 (KR) 10-2026-0071501

(51) Int. Cl. H04B 7/06; H04W 24/10

(52) U.S. Cl. CPC H04B 7/0617; H04W 24/10

(57) ABSTRACT

A method of a base station may comprise: configuring a communication performance package (CPP) including at least one performance metric; transmitting the CPP to a terminal; receiving, from the terminal, a CPP report including measurement results for the at least one performance metric; determining whether the measurement results of the CPP report satisfy a CPP target criterion (CPPT); and based on the measurement results not satisfying the CPPT, controlling a beamforming operation of at least one of a relay or the terminal.

### CROSS-REFERENCE TO RELATED APPLICATIONS

This application claims priority to Korean Patent Applications No. 10-2025-0053726, filed on Apr. 24, 2025, and No. 10-2026-0071501, filed on Apr. 21, 2026, with the Korean Intellectual Property Office (KIPO), the entire contents of which are hereby incorporated by reference.

### BACKGROUND

### 1. Technical Field

The present disclosure relates to a communication system using a relay, and more particularly, to a method and an apparatus for controlling a beamforming operation of a relay or a terminal based on communication performance metrics between a base station and the terminal.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, research for utilizing a relay in a communication system has been actively conducted. The relay plays an important role in network scalability and signal quality improvement of the communication system, and may be efficiently utilized particularly in an urban area or a complex network environment. The relay may include a reconfigurable intelligent surface (RIS) controlled by a network or a network-controlled repeater (NCR). The RIS is a passive relay configured with a plurality of passive elements and reflects a signal without active signal processing, and the NCR may be an active relay capable of active signal processing and channel state measurement.

The communication system may guarantee user-customized quality of service (QoS) through network intelligence by using the relay. The communication system may prevent degradation of communication performance of the network by controlling a beamforming operation of a base station, a terminal, or the relay through monitoring of a network state for guaranteeing the user-customized QoS. However, in a conventional communication system, metrics for comprehensively evaluating a network state are not sufficient, and thus there is a limitation in effective beamforming operation control. Accordingly, there is a need for a method capable of evaluating the network state by comprehensively analyzing various performance metrics and effectively controlling beamforming operations of the relay based on the evaluation.

### SUMMARY

The present disclosure for resolving the above-described problems is directed to providing a method and an apparatus for controlling a beamforming operation of a relay or a terminal based on communication performance metrics of a communication system.

According to a first exemplary embodiment of the present disclosure, a method of a base station may comprise: configuring a communication performance package (CPP) including at least one performance metric; transmitting the CPP to a terminal; receiving, from the terminal, a CPP report including measurement results for the at least one performance metric; determining whether the measurement results of the CPP report satisfy a CPP target criterion (CPPT); and based on the measurement results not satisfying the CPPT, controlling a beamforming operation of at least one of a relay or the terminal.

The controlling of the beamforming operation may comprise: generating a beamformer adjustment command for controlling the beamforming operation; and transmitting the beamformer adjustment command to at least one of the relay or the terminal.

The generating of the beamformer adjustment command may comprise: defining an optimization problem based on the at least one performance metric of the CPP; and generating the beamformer adjustment command for adjusting at least one of a transmit beamformer of the terminal, a receive beamformer of the terminal, or reflection coefficients of the relay based on a solution to the defined optimization problem.

The controlling of the beamforming operation may comprise: receiving, from a gateway, at least one channel distribution parameter and location information of the terminal; determining an average azimuth angle and an azimuth angle variance of the base station; determining channel distribution information based on at least one of: the at least one channel distribution parameter, the location information of the terminal, the average azimuth angle, or the azimuth angle variance; defining an optimization problem based on the channel distribution information; and generating the beamformer adjustment command for adjusting reflection coefficients of the relay based on a solution to the defined optimization problem.

The method may further comprise receiving, from the gateway, at least one system parameter for obtaining the solution to the defined optimization problem.

The determining of the channel distribution information may comprise: determining at least one of an inter-node distance, an angle of arrival (AoA), or an angle of departure (AoD) based on at least one of location information of the base station, location information of the relay, or the location information of the terminal; determining path loss based on the inter-node distance; modeling a distribution of AoA and AoD based on at least one of the AoA, the AoD, the average azimuth angle, or the azimuth angle variance; modeling a Rician channel based on the at least one channel distribution parameter; and determining the channel distribution information based on at least one of the path loss, the modeling of the AoA/AOD distribution, or the modeling of the Rician channel.

The method may further comprise decreasing a CPP reporting periodicity of the terminal relative to a default reporting periodicity.

The method may further comprise, based on the measurement results satisfying the CPPT, increasing the CPP reporting periodicity of the terminal relative to a default reporting periodicity.

The configuring of the CPP may comprise: transmitting, to the terminal, a performance metric candidate group including a plurality of performance metrics; receiving, from the terminal, a performance metric report including at least one performance metric measurable by the terminal from among the performance metric candidate group; and configuring the CPP including at least one measurement metric, key metric, or composite metric based on the performance metric report.

The method may further comprise: determining a CPP additional metric by performing additional computation for a performance metric included in the CPP report; and determining whether the CPP additional metric satisfies the CPPT.

According to a second exemplary embodiment of the present disclosure, a method of a terminal may comprise: receiving, from a base station, a communication performance package (CPP) including at least one performance metric; measuring the at least one performance metric; transmitting, to the base station, a CPP report including measurement results for the at least one performance metric; receiving, from the base station, a beamformer adjustment command based on the CPP report not satisfying a CPP target criterion (CPPT); and controlling a beamforming operation of at least one of a transmit beamformer or a receive beamformer based on the beamformer adjustment command.

The method may further comprise: receiving, from the base station, a CPP reporting periodicity adjustment command; and decreasing a CPP reporting periodicity relative to a default reporting periodicity based on the CPP reporting periodicity adjustment command.

The method may further comprise: receiving, from the base station, a CPP reporting periodicity adjustment command based on the CPP report satisfying the CPPT; and increasing a CPP reporting periodicity relative to a default reporting periodicity based on the CPP reporting periodicity adjustment command.

The method may further comprise: receiving, from the base station, a performance metric candidate group including the at least one performance metric; transmitting, to the base station, a performance metric report including at least one performance metric measurable by the terminal from among the performance metric candidate group; and receiving, from the base station, the CPP including at least one measurement metric, key metric, or composite metric based on the performance metric report.

According to a third exemplary embodiment of the present disclosure, a base station may comprise at least one processor, and the at least one processor may cause the base station to perform: configuring a communication performance package (CPP) including at least one performance metric; transmitting the CPP to a terminal; receiving, from the terminal, a CPP report including measurement results for the at least one performance metric; determining whether the measurement results of the CPP report satisfy a CPP target criterion (CPPT); based on the measurement results not satisfying the CPPT, generating a beamformer adjustment command for controlling a beamforming operation of at least one of a relay or the terminal; and transmitting the beamformer adjustment command to at least one of the relay or the terminal.

In the generating of the beamformer adjustment command, the at least one processor may further cause the base station to perform: defining an optimization problem based on the at least one performance metric of the CPP; and generating the beamformer adjustment command for adjusting at least one of a transmit beamformer of the terminal, a receive beamformer of the terminal, or reflection coefficients of the relay based on a solution to the defined optimization problem.

In the controlling of the beamforming operation, the at least one processor may further cause the base station to perform: receiving, from a gateway, at least one channel distribution parameter and location information of the terminal; determining an average azimuth angle and an azimuth angle variance of the base station; determining channel distribution information based on at least one of: the at least one channel distribution parameter, the location information of the terminal, the average azimuth angle, or the azimuth angle variance; defining an optimization problem based on the channel distribution information; and generating the beamformer adjustment command for adjusting reflection coefficients of the relay based on a solution to the defined optimization problem.

The at least one processor may further cause the base station to perform decreasing a CPP reporting periodicity of the terminal relative to a default reporting periodicity.

The at least one processor may further cause the base station to perform: based on the measurement results satisfying the CPPT, increasing the CPP reporting periodicity of the terminal relative to a default reporting periodicity.

In the configuring of the CPP, the at least one processor may further cause the base station to perform: transmitting, to the terminal, a performance metric candidate group including a plurality of performance metrics; receiving, from the terminal, a performance metric report including at least one performance metric measurable by the terminal from among the performance metric candidate group; and configuring the CPP including at least one measurement metric, key metric, or composite metric based on the performance metric report.

According to the present disclosure, a base station can control beamforming operations of a relay or a terminal based on measurement and calculation results for various performance metrics of a communication performance package received from the terminal. Through this, the base station can improve communication quality between the relay and the terminal, and can rapidly respond to changes in a network state, thereby improving performance of the communication network.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of a communication network including a relay.

FIG. 4 is a flowchart illustrating an exemplary embodiment of a method for controlling a beamforming operation based on communication performance with a terminal.

FIG. 5 is a sequence diagram illustrating an exemplary embodiment of a method for configuring and reporting a communication performance package between a base station and a terminal.

FIG. 6 is a conceptual diagram illustrating an exemplary embodiment of a communication performance package.

FIG. 7 is a sequence diagram illustrating an exemplary embodiment of a method in which a base station adjusts a reporting periodicity of a terminal when a communication performance package satisfies a target criterion.

FIG. 8 is a sequence diagram illustrating another exemplary embodiment of a method in which a base station adjusts a reporting periodicity of a terminal when a communication performance package satisfies a target criterion.

FIG. 9 is a sequence diagram illustrating an exemplary embodiment of a method in which a base station controls a beamforming operation when a communication performance package does not satisfy a target criterion.

FIG. 10 is a sequence diagram illustrating another exemplary embodiment of a method in which a base station controls a beamforming operation when a communication performance package does not satisfy a target criterion.

FIG. 11 is a sequence diagram illustrating an exemplary embodiment of a method in which a base station obtains channel distribution information for controlling a beamforming operation of a relay in a non-terrestrial network.

FIG. 12 is a sequence diagram illustrating an exemplary embodiment of a method in which a base station controls a beamforming operation of a relay based on channel distribution information in a non-terrestrial network.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G (or 6GR) mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

In the present disclosure, a relay may perform, in terms of operation, a role similar to that of a terminal with respect to a base station, and a role similar to that of a base station with respect to a terminal. For example, the relay may operate similarly to a terminal in terms of receiving control information from the base station, and may operate similarly to a base station in terms of relaying signals to the terminal. In the following description, operations are mainly described based on a base station and a terminal for convenience of description, and procedures or methods presented in the present disclosure are not limited to operations between the base station and the terminal. An operation between a terminal and a base station may also be understood as an operation between the base station and a relay, or between the relay and the terminal. The relay may include, depending on the type and function of the relay, both a passive relay (e.g. a reconfigurable intelligent surface (RIS)) that cannot perform active signal processing or real-time channel state measurement and an active relay (e.g. a network-controlled repeater (NCR)) capable of active signal processing or real-time channel state measurement. The active relay may operate similarly to a terminal in that the active relay may receive control information from a base station, measure performance metrics for a channel between the relay and the terminal, and report measurement results to the base station.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like. Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

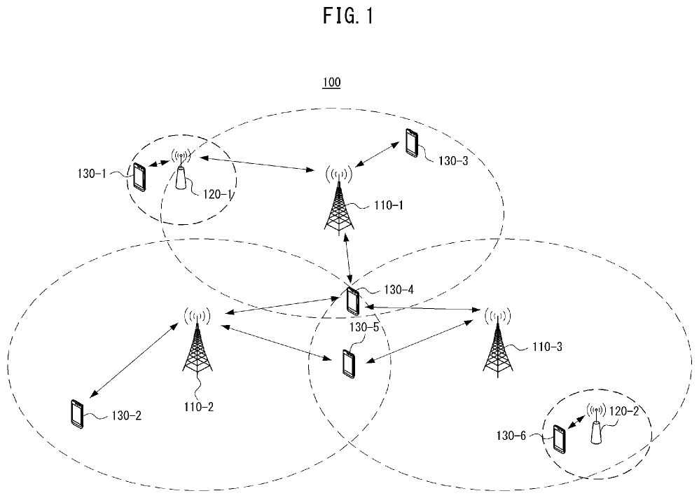

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

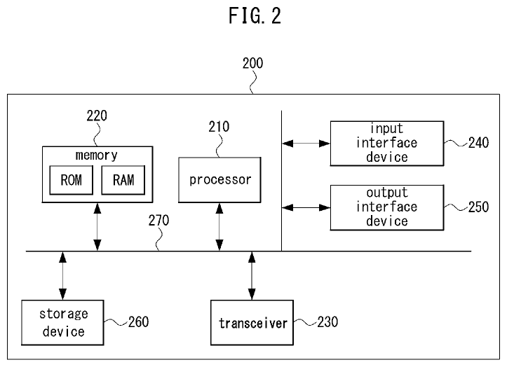

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

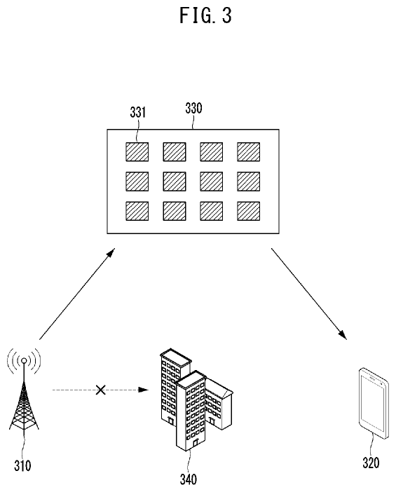

FIG. 3 is a conceptual diagram illustrating an exemplary embodiment of a communication network including a relay.

Referring to FIG. 3, a communication network may include a relay 330. The relay 330 may relay RF signals or beamforming signals between a base station 310 and a terminal 320 in the communication network and may play an important role in network coverage expansion or signal quality improvement. For example, in an urban network environment, an obstacle 340 such as a building may exist between the base station 310 and the terminal 320. The base station 310 may have difficulty in securing a line of sight (LOS) path with the terminal 320 due to the obstacle 340, and accordingly, the signal strength of a signal transmitted between the base station 310 and the terminal 320 may be reduced. Accordingly, the base station 310 may transmit signals to the terminal 320 via the relay 330, thereby mitigating signal attenuation due to the obstacle 340 and preventing degradation of signal quality.

The relay 330 may be either an RIS or an NCR. In FIG. 3, the relay 330 is illustrated as an RIS by way of example. The RIS 330 may include a two-dimensional metasurface configured with a plurality of passive elements 331 and a control module (not shown) capable of adjusting reflection coefficients of the plurality of passive elements 331. The reflection coefficient may be a phase, amplitude, or polarization state of each passive element. The control module may dynamically adjust the reflection coefficient of each of the plurality of passive elements 331 based on a control signal received from the base station 310. According to an exemplary embodiment, when the relay 330 is an NCR, the NCR 330 may be capable of active signal processing and real-time channel state measurement. The relay 330 may measure a performance metric for a channel with the terminal 320 based on control information (e.g. a communication performance package (CPP)) received from the base station 310 and may transmit a CPP report including measurement results to the base station 310. The base station 310 may generate a beamformer adjustment command for controlling a beamforming operation of the relay 330 based on the CPP report received from the relay 330 and may transmit the beamformer adjustment command to the relay 330. The relay 330 may control a beamforming operation based on the beamformer adjustment command received from the base station 310.

The base station 310 may control a beamforming operation of the relay 330 or the terminal 320 in order to optimize communication performance using the relay 330. The base station 310 may determine a current communication state between the base station 310 and the terminal 320 based on an metric representing communication performance with the terminal 320. The base station 310 may transmit a beamformer adjustment command to the relay 330 or the terminal 320 based on the determination result.

The relay 330 may adjust the reflection coefficients of the plurality of passive elements 331 based on the beamformer adjustment command received from the base station 310. The terminal 320 may adjust at least one of a transmit beamformer or a receive beamformer based on the beamformer adjustment command received from the base station 310. Accordingly, the base station 310 may optimize beamforming for a communication path with the terminal 320 via the relay 330, and thereby may improve signal strength and quality of communication with the terminal 320.

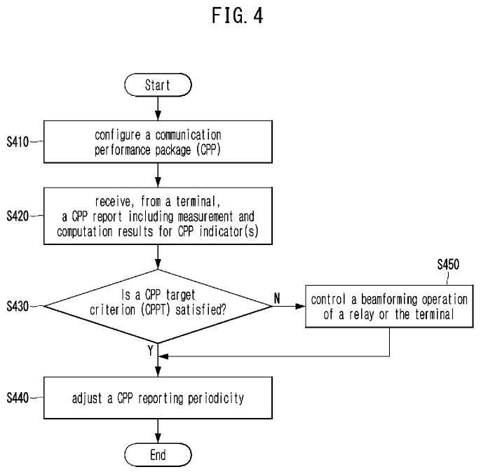

FIG. 4 is a flowchart illustrating an exemplary embodiment of a method for controlling a beamforming operation based on communication performance with a terminal.

Referring to FIG. 4, the base station may configure a CPP including at least one performance metric for determining a communication state with the terminal (S410). The base station may configure the CPP based on at least one of network environment or terminal characteristics. The CPP may include value(s) representing communication performance between the base station and the terminal and may include at least one performance metric among a measurement metric, a key metric, or a composite metric.

The measurement metric may be a value that the terminal may obtain by measuring a reference signal (RS) received from the base station. The measurement metric may include at least one of outage probability, block error rate (BLER), bit error rate (BER), signal-to-noise ratio (SNR), throughput, or delay. According to an exemplary embodiment, the measurement metric may include at least one of synchronization signal-reference signal received power (SS-RSRP), channel state information-RSRP (CSI-RSRP), synchronization signal-reference signal received quality (SS-RSRQ), channel state information-RSRQ (CSI-RSRQ), synchronization signal-signal to interference plus noise ratio (SS-SINR), received signal strength indicator (RSSI), or channel quality indicator (CQI).

The key metric may be a value determined through computation based on at least one measurement metric. The key metric may include at least one of data rate, energy efficiency, spectral efficiency, latency, or reliability.

The composite metric may be a value determined through a combination of some or all of the measurement metrics and the key metrics. The composite metric may provide an integrated interpretation of communication performance between the base station and the terminal. According to an exemplary embodiment, the base station may apply a weight to a measurement metric or a key metric based on a priority defined by a configured operation policy and may determine the composite metric based on the applied weight.

The base station may transmit the configured CPP to the terminal. The terminal may perform measurement or computation for at least one metric of the CPP received from the base station, for example, at least one measurement metric or key metric. For example, the terminal may perform measurement for CPP metric(s) (i.e. at least one measurement metric of the CPP or may perform computation for at least one key metric of the CPP). The terminal may transmit a CPP report including CPP measurement or computation results to the base station (S420).

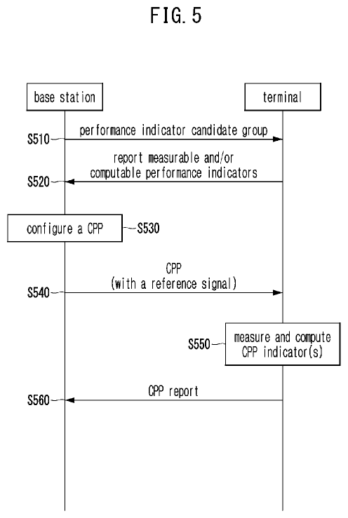

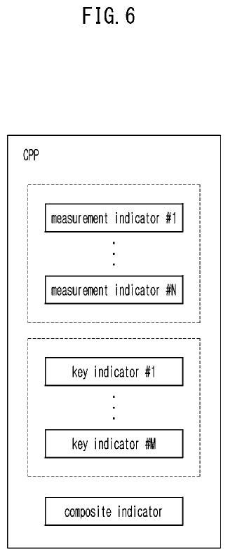

FIG. 5 is a sequence diagram illustrating an exemplary embodiment of a method for configuring and reporting a communication performance package between a base station and a terminal, and FIG. 6 is a conceptual diagram illustrating an exemplary embodiment of a communication performance package.

Referring to FIG. 5, the base station may transmit, to the terminal, a performance metric candidate group including at least one measurement metric or key metric for configuring a CPP (S510). The terminal may determine at least one measurable performance metric or at least one computable performance metric from among the performance metric candidate group received from the base station. The terminal may report the determined performance metric(s) to the base station (S520).

The base station may configure a CPP based on the performance metric(s) reported from the terminal (S530). As illustrated in FIG. 6, the CPP may include N measurement metrics based on the performance metric(s) received from the terminal, M key metrics determined based on the N measurement metrics, and a composite metric determined by combining at least some of the N measurement metrics and the M key metrics.

For example, the measurement metrics of the CPP may include SS-SINR, BLER, and an outage probability. The key metrics may include a data rate determined based on SS-SINR among the measurement metrics and reliability determined through computation on BLER or outage probability among the measurement metrics. The composite metric may be an metric determined through a combination of the data rate and reliability of the key metrics.

Here, the data rate may be determined based on Equation 1, the reliability may be determined based on Equation 2, and the composite metric may be determined based on Equation 3.

f₁=log₂(1+SS−SINR) [Equation 1]

f₂=(1−BLER)(1−P_{outage}) [Equation 2]

Here, P_{outage} may be outage probability.

f₃=αf₁+(1−α)βf₂, 0≤α≤1 [Equation 3]

Here, a may represent importance, and β may be a scaling variable.

The base station may transmit the configured CPP to the terminal. According to an exemplary embodiment, the base station may transmit the CPP to the terminal together with a pilot signal (S540). The pilot signal may include a reference signal for measurement of at least one CPP metric.

The terminal may measure the reference signal based on at least one measurement metric of the CPP received from the base station. The terminal may perform computation for at least one key metric of the CPP using measurement results (S550). The terminal may transmit a CPP report including measurement results or computation results for the CPP metric(s) to the base station (S560).

According to an exemplary embodiment, the base station may transmit the CPP to the terminal excluding a pilot signal. The terminal may perform measurement or computation for at least one metric of the CPP received from the base station. The terminal may transmit a CPP report including measurement results or computation results for the CPP metric(s) to the base station.

Referring again to FIG. 4, the base station may determine whether CPP measurement and computation results satisfy a target criterion (i.e. CPP target criterion (CPPT)) based on the CPP report received from the terminal (S430). According to an exemplary embodiment, the base station may determine whether at least one measurement metric or key metric included in the CPP report satisfies the target criterion. According to an exemplary embodiment, the base station may determine a composite metric by combining at least one measurement metric and key metric included in the CPP report and may determine whether the determined composite metric satisfies the target criterion.

When the CPP report satisfies the target criterion, the base station may adjust a CPP reporting periodicity of the terminal (S440). According to an exemplary embodiment, the base station may adjust the CPP reporting periodicity of the terminal to a default reporting periodicity. According to another exemplary embodiment, when the CPP report received from the terminal satisfies the target criterion consecutively for at least a predetermined number of times, the base station may adjust the CPP reporting periodicity of the terminal to a longer reporting periodicity compared to the default reporting periodicity.

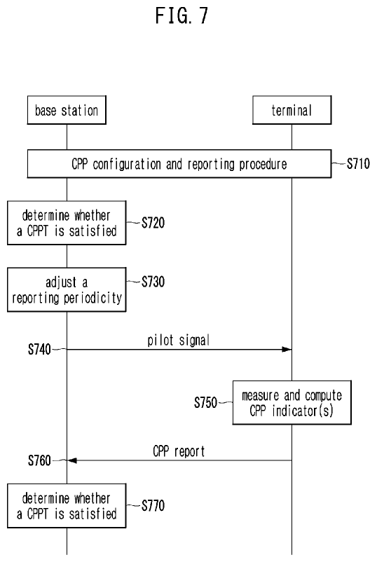

FIG. 7 is a sequence diagram illustrating an exemplary embodiment of a method in which a base station adjusts a reporting periodicity of a terminal when a communication performance package satisfies a target criterion.

Referring to FIG. 7, the base station may perform a CPP configuration and reporting procedure with the terminal (S710). Since the CPP configuration and reporting procedure is substantially the same as the procedure described above with reference to FIG. 5, a detailed description thereof is omitted.

The base station may receive, from the terminal, a CPP report including CPP measurement results or computation results. The base station may determine whether at least one metric included in the received CPP report satisfies the target criterion (i.e. CPPT) (S720).

When at least one metric of the CPP report received from the terminal satisfies the target criterion, the base station may adjust the CPP reporting periodicity of the terminal (S730). The base station may adjust the CPP reporting periodicity of the terminal to the default reporting periodicity or to a longer reporting periodicity compared to the default reporting periodicity.

The base station may transmit a pilot signal to the terminal (S740). The pilot signal may include at least one reference signal for CPP measurement of the terminal. According to an exemplary embodiment, the base station may transmit, to the terminal, a control command for changing the CPP reporting periodicity of the terminal separately from the pilot signal, for example, a CPP reporting periodicity adjustment command. The CPP reporting periodicity adjustment command may include CPP reporting periodicity change information. According to an exemplary embodiment, the base station may transmit the CPP reporting periodicity adjustment command to the terminal using the same time or frequency resource as the pilot signal or using a separate time or frequency resource. According to another exemplary embodiment, the base station may not transmit the pilot signal to the terminal and may transmit the CPP reporting periodicity adjustment command to the terminal.

The terminal may measure the reference signal based on at least one measurement metric of the CPP. The terminal may perform computation for at least one key metric of the CPP using measurement results of the reference signal (S750). Here, the terminal may perform the reference signal measurement and computation using the CPP received from the base station through the aforementioned CPP configuration and reporting procedure (S710).

The terminal may transmit, to the base station, a CPP report including CPP measurement and computation results based on a changed CPP reporting periodicity of the CPP reporting periodicity adjustment command received from the base station (S760). The base station may determine whether at least one metric of the CPP report received from the terminal satisfies the target criterion (S770).

According to an exemplary embodiment, among the steps illustrated in FIG. 7, steps other than the CPP configuration and reporting procedure S710 between the base station and the terminal may be repeated a predetermined number of times. The base station may determine whether the CPP report received from the terminal satisfies the target criterion for each repetition and may adjust the CPP reporting periodicity of the terminal accordingly. According to an exemplary embodiment, when the CPP report received from the terminal continuously satisfies the target criterion for at least a predetermined number of times, the base station may adjust the CPP reporting periodicity of the terminal to a longer reporting periodicity compared to the default reporting periodicity.

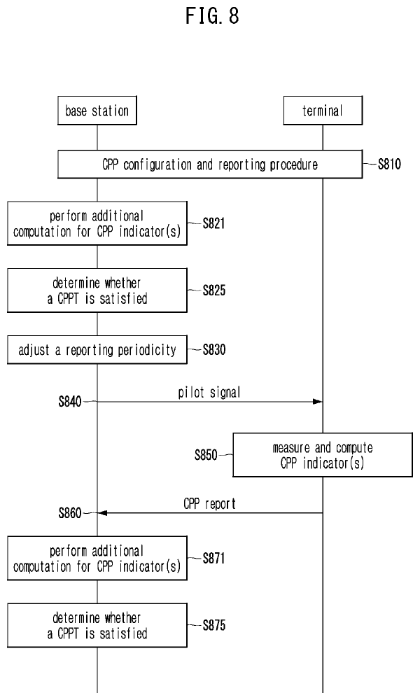

FIG. 8 is a sequence diagram illustrating another exemplary embodiment of a method in which a base station adjusts a reporting periodicity of a terminal when a communication performance package satisfies a target criterion.

Referring to FIG. 8, the base station may perform a CPP configuration and reporting procedure with the terminal (S810). Since the CPP configuration and reporting procedure is substantially the same as the procedure described above with reference to FIG. 5, a detailed description thereof is omitted.

The base station may perform additional computation for at least one metric of the CPP based on the CPP report received from the terminal (S821). According to an exemplary embodiment, the base station may configure a CPP including SNR as a measurement metric and spectral efficiency as a key metric according to the CPP configuration and reporting procedure (S810). The base station may receive, from the terminal, a CPP report including measurement results for the measurement metric of the CPP and computation results for the key metric. The base station may perform additional computation for a CPP metric based on the received CPP report to determine a CPP additional metric, for example, an energy efficiency metric. The base station may determine the energy efficiency metric as shown in Equation 4 below based on total power consumption.

energy efficiency=log₂(1+SNR)/(total power consumption) [Equation 4]

Here, total power consumption may denote total power consumption.

According to an exemplary embodiment, the base station may determine a composite metric as shown in Equation 5 below by combining a spectral efficiency metric included in the CPP report and an energy efficiency metric determined through additional computation.

f₂=α·(spectral efficiency)+(1−α)β·(energy efficiency), 0≤α≤1 [Equation 5]

Here, a may represent importance, and β may be a scaling variable.

The base station may determine whether at least one of the CPP report received from the terminal or the CPP additional metric determined through additional computation satisfies the target criterion (CPPT) (S825).

When the CPP report or the CPP additional metric satisfies the target criterion, the base station may adjust the CPP reporting periodicity of the terminal (S830). The base station may adjust the CPP reporting periodicity of the terminal to the default reporting periodicity or to a longer reporting periodicity compared to the default reporting periodicity.

The base station may transmit a pilot signal to the terminal (S840). The pilot signal may include at least one reference signal for CPP measurement of the terminal. According to an exemplary embodiment, the base station may transmit, to the terminal, a CPP reporting periodicity adjustment command including CPP reporting periodicity change information separately from the pilot signal. The base station may transmit the CPP reporting periodicity adjustment command to the terminal through the same time or frequency resource as the pilot signal or through a separate time or frequency resource. According to another exemplary embodiment, the base station may not transmit the pilot signal to the terminal and may transmit the CPP reporting periodicity adjustment command to the terminal.

The terminal may measure the reference signal based on at least one measurement metric of the CPP. The terminal may perform computation for at least one key metric of the CPP using measurement results of the reference signal (S850). Here, the terminal may perform the reference signal measurement and computation using the CPP received from the base station through the aforementioned CPP configuration and reporting procedure (S810).

The terminal may transmit, to the base station, a CPP report including CPP measurement and computation results based on a changed CPP reporting periodicity indicated by the CPP reporting periodicity adjustment command received from the base station (S860). The base station may perform additional computation for a CPP metric of the CPP report received from the terminal to determine a CPP additional metric (S871). According to an exemplary embodiment, the additional computation for the CPP metric in this step S871 may be the same as the additional computation for the CPP metric in the aforementioned step S821. The base station may determine whether at least one of the CPP report received from the terminal or the CPP additional metric determined through additional computation satisfies the target criterion (CPPT) (S875).

Referring again to FIG. 4, when the CPP report received from the terminal does not satisfy the target criterion, the base station may control a beamforming operation of at least one of the relay or the terminal (S450). For example, the base station may transmit, to the relay, a beamformer adjustment command capable of adjusting reflection coefficients of a plurality of passive elements of the relay. In addition, the base station may transmit, to the terminal, a beamformer adjustment command capable of adjusting transmit and receive beamforming of the terminal. Here, the base station may transmit the beamformer adjustment command to the terminal via the relay.

After controlling the beamforming operation of at least one of the relay or the terminal, the base station may adjust the CPP reporting periodicity of the terminal (S440). According to an exemplary embodiment, the base station may adjust the CPP reporting periodicity of the terminal to a shorter reporting periodicity compared to the default reporting periodicity. According to another exemplary embodiment, when the CPP report received from the terminal continuously fails to satisfy the target criterion for at least a predetermined number of times, the base station may adjust the CPP reporting periodicity of the terminal to a shorter reporting periodicity compared to the default reporting periodicity.

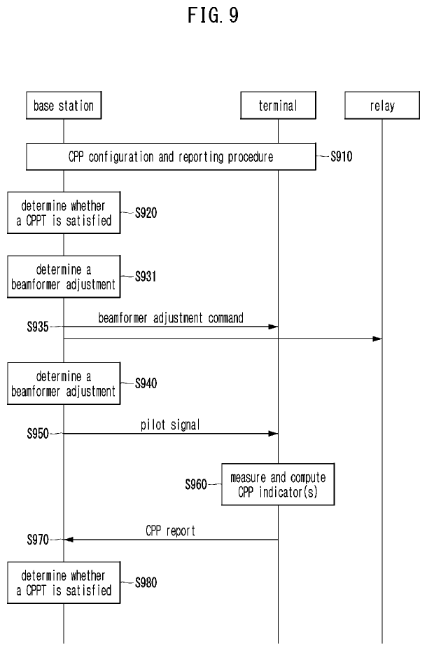

FIG. 9 is a sequence diagram illustrating an exemplary embodiment of a method in which a base station controls a beamforming operation when a communication performance package does not satisfy a target criterion.

Referring to FIG. 9, the base station may perform a CPP configuration and reporting procedure with the terminal (S910). Since the CPP configuration and reporting procedure is substantially the same as the procedure described above with reference to FIG. 5, a detailed description thereof is omitted.

The base station may receive, from the terminal, a CPP report including CPP measurement results or computation results. The base station may determine whether at least one metric included in the received CPP report satisfies the target criterion (CPPT) (S920).

When at least one metric of the CPP report received from the terminal does not satisfy the target criterion, the base station may determine a beamformer adjustment for at least one of the relay and the terminal (S931). The base station may transmit, to the terminal or the relay, a control command for controlling a beamforming operation of the relay or the terminal, for example, a beamformer adjustment command (S935). The beamformer adjustment command may include beamformer adjustment information of the relay or the terminal, which is determined by the base station. The terminal may control at least one beamforming operation of a transmit beamformer or a receive beamformer based on the beamformer adjustment command received from the base station. The relay may control the beamforming operation by adjusting reflection coefficients of a plurality of passive elements based on the beamformer adjustment command received from the base station.

According to an exemplary embodiment, the base station may generate the beamformer adjustment command by solving an optimization problem based on the CPP report of the terminal. For example, the base station may formulate an optimization problem such that all metrics of the CPP report received from the terminal satisfy the target criterion as shown in Equation 6 below. The base station may generate a beamformer adjustment command for the relay or the terminal by solving the optimization problem of Equation 6.

$${max}_{f , w , Θ} SS - SINR \qquad [ Equation 6 ]$$

$$s . t .$$

$$( SS - SINR ) > ( SS - SINR criterion )$$

$$( BLER ) < ( BLER criterion )$$

$$( Outage probability ) < ( Outage probability criterion )$$

$${f}_{1} ( SS - SINR ) > ( {f}_{1} ( SS - SINR ) criterion )$$

$${f}_{2} ( BLER , outage probability ) > ( {f}_{2} ( BLER , outage probability ) criterion )$$

$${f}_{3} ( SS - SINR , BLER , outage probability ) > ( {f}_{3} ( SS - SINR , BLER , outage probability ) criterion )$$

Here, f may indicate a transmit beamforming vector of the terminal, w may indicate a receive beamforming vector of the terminal, Θ may indicate a reflection coefficient matrix (or vector) of the relay, f₁ may indicate a measurement metric of the CPP, f₂ may indicate a key metric of the CPP, f₃ may indicate a composite metric of the CPP, and criterion may indicate a target criterion for each metric.

When a solution to the optimization problem of Equation 6 is obtained as {f*, w*, Θ*}, the base station may generate a receive beamformer adjustment command for controlling a beamforming operation of the terminal using w*, and may generate a relay beamformer adjustment command for controlling a beamforming operation of the relay using Θ*.

According to an exemplary embodiment, the base station may generate a beamformer adjustment command by additionally using a beam codebook in the optimization problem solving method described above. For example, the base station may solve the optimization problem by adding a constraint as shown in Equation 7 below to Equation 6 described above.

f∈F,w∈W,Θ∈Φ [Equation 7]

Here, f may indicate the transmit beamforming vector of the terminal, w may indicate the receive beamforming vector of the terminal, Θ may indicate the reflection coefficient matrix (or vector) of the relay, F may indicate a transmit beamformer codebook of the terminal, W may indicate a receive beamformer codebook of the terminal, and Φ may indicate a relay beamformer codebook.

The base station may derive a solution to the optimization problem of Equation 6 to which the constraint condition of Equation 7 is added and may generate a beamformer adjustment command for controlling a beamforming operation of the terminal or the relay based on the derived solution.

The base station may adjust the CPP reporting periodicity of the terminal after at least one beamformer of the relay or the terminal is adjusted (S940). According to an exemplary embodiment, the base station may adjust the CPP reporting periodicity of the terminal to a shorter reporting periodicity compared to the default reporting periodicity. According to another exemplary embodiment, when the CPP report received from the terminal continuously fails to satisfy a target criterion for at least a predetermined number of times, the base station may adjust the CPP reporting periodicity of the terminal to a shorter reporting periodicity compared to the default reporting periodicity.

The base station may transmit a pilot signal to the terminal (S950). The pilot signal may include at least one reference signal for CPP measurement of the terminal. According to an exemplary embodiment, the base station may transmit, to the terminal, a CPP reporting periodicity adjustment command including CPP reporting periodicity change information separately from the pilot signal. The base station may transmit the CPP reporting periodicity adjustment command to the terminal through the same time or frequency resource as the pilot signal or through a separate time or frequency resource. According to another exemplary embodiment, the base station may not transmit the pilot signal to the terminal and may transmit the CPP reporting periodicity adjustment command to the terminal.

The terminal may measure the reference signal based on at least one measurement metric of the CPP. The terminal may perform computation for at least one key metric of the CPP using measurement results of the reference signal (S960). Here, the terminal may perform reference signal measurement and computation using the CPP received from the base station through the aforementioned CPP configuration and reporting procedure (S910).

The terminal may transmit, to the base station, a CPP report including CPP measurement and computation results based on a changed CPP reporting periodicity indicated by the CPP reporting periodicity adjustment command received from the base station (S970). The base station may determine whether an metric included in the CPP report received from the terminal satisfies the target criterion (S980).

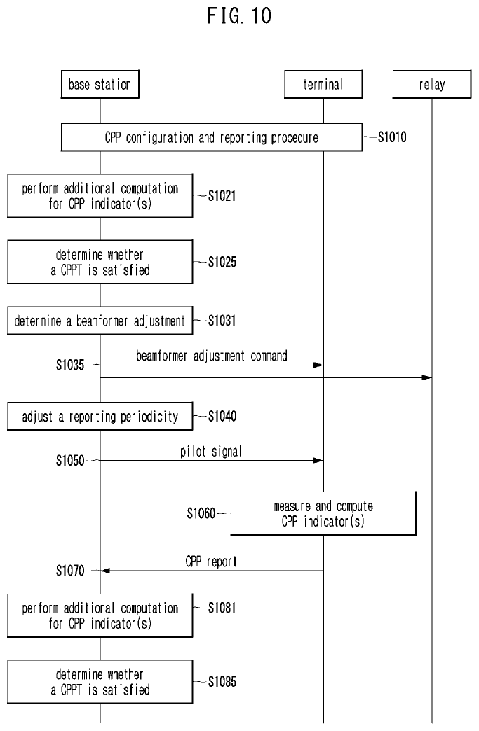

FIG. 10 is a sequence diagram illustrating another exemplary embodiment of a method in which a base station controls a beamforming operation when a communication performance package does not satisfy a target criterion.

Referring to FIG. 10, the base station may perform a CPP configuration and reporting procedure with the terminal (S1010). Since the CPP configuration and reporting procedure is substantially the same as the procedure described above with reference to FIG. 5, a detailed description thereof is omitted.

The base station may perform additional computation for at least one CPP metric based on a CPP report received from the terminal (S1021). According to an exemplary embodiment, the base station may configure a CPP including SS-SINR as a measurement metric through the CPP configuration and reporting procedure (S1010). The base station may receive, from the terminal, a CPP report including measurement results for the CPP measurement metric. Here, when a target criterion (CPPT) is an outage probability, the base station may perform additional computation for determining an additional metric, that is, outage probability, based on the received CPP report. For example, the base station may compare an SS-SINR value of the CPP report with a predetermined SS-SINR value, and may determine whether an outage occurs based on a comparison result. The base station may accumulate the determination results to determine the outage probability metric of the CPP.

The base station may determine whether the CPP additional metric determined through the additional computation, that is, the outage probability metric, satisfies the target criterion (CPPT) (S1025). When the CPP additional metric does not satisfy the target criterion, the base station may determine a beamformer adjustment for the relay or the terminal (S1031). The base station may transmit a beamformer adjustment command for controlling a beamforming operation to the terminal or the relay (S1035).

The beamformer adjustment command may include beamformer adjustment information of the relay or the terminal, which is determined by the base station. According to an exemplary embodiment, the base station may determine the beamformer adjustment information by solving an optimization problem for the CPP additional metric. According to another exemplary embodiment, the base station may determine the beamformer adjustment information by solving an optimization problem including a constraint condition based on a beamformer codebook.

The terminal may control at least one beamforming operation of a transmit beamformer or a receive beamformer based on the beamformer adjustment command received from the base station. The relay may control a beamforming operation by adjusting reflection coefficients of a plurality of passive elements based on the beamformer adjustment command received from the base station.

The base station may adjust the CPP reporting periodicity of the terminal after at least one beamformer of the relay or the terminal is adjusted (S1040). According to an exemplary embodiment, the base station may adjust the CPP reporting periodicity of the terminal to a shorter reporting periodicity compared to the default reporting periodicity. According to another exemplary embodiment, when the CPP report received from the terminal continuously fails to satisfy the target criterion for at least a predetermined number of times, the base station may adjust the CPP reporting periodicity of the terminal to a shorter reporting periodicity compared to the default reporting periodicity.

The base station may transmit a pilot signal to the terminal (S1050). The pilot signal may include at least one reference signal for CPP measurement of the terminal. According to an exemplary embodiment, the base station may transmit, to the terminal, a CPP reporting periodicity adjustment command including CPP reporting periodicity change information separately from the pilot signal. The base station may transmit the CPP reporting periodicity adjustment command to the terminal through the same time or frequency resource as the pilot signal or through a separate time or frequency resource. According to another exemplary embodiment, the base station may not transmit the pilot signal to the terminal and may transmit the CPP reporting periodicity adjustment command to the terminal.

The terminal may measure the reference signal based on at least one measurement metric of the CPP. The terminal may perform computation for at least one key metric of the CPP using measurement results of the reference signal (S1060). Here, the terminal may perform reference signal measurement and computation using the CPP received from the base station through the aforementioned CPP configuration and reporting procedure (S1010).

The terminal may transmit, to the base station, a CPP report including CPP measurement and computation results based on a changed CPP reporting periodicity indicated by the CPP reporting periodicity adjustment command received from the base station (S1070). The base station may perform additional computation for the CPP metric based on the CPP report received from the terminal. The base station may determine a CPP additional metric, for example, an outage probability metric, through the additional computation (S1081). The base station may determine whether the CPP additional metric satisfies the target criterion (CPPT) (S1085).

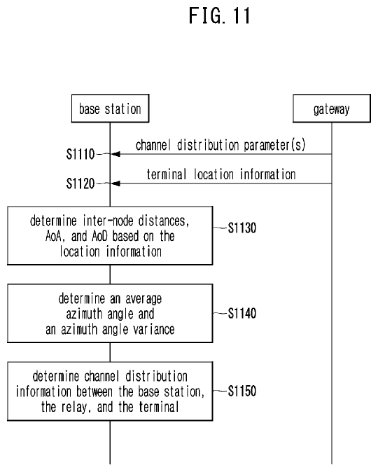

FIG. 11 is a sequence diagram illustrating an exemplary embodiment of a method in which a base station obtains channel distribution information for controlling a beamforming operation of a relay in a non-terrestrial network.

Hereinafter, a method in which an aerial base station such as an unmanned aerial vehicle (UAV) controls a beamforming operation of a terminal or a relay in a non-terrestrial network (NTN) environment is described.

In the NTN environment, the base station may have difficulty in securing instantaneous channel state information due to characteristics of a passive relay including a plurality of passive elements. Here, the relay characteristic may refer to the fact that the passive relay is not capable of performing active signal processing or real-time channel state measurement due to the passive elements. Accordingly, the base station may determine a channel state between a relay and a terminal through signaling with a ground gateway, for example, transmission and reception of control information, and may control a beamforming operation of the relay based on the determined channel state.

According to an exemplary embodiment, in the NTN environment, an active relay may include an active signal processing module to process and retransmit a received signal, and may perform real-time channel state measurement and reporting functions. The active relay may operate similarly to a terminal, and for example, may receive a CPP from the base station, measure at least one performance metric, and transmit a CPP report to the base station.

Referring to FIG. 11, the base station may receive at least one channel distribution parameter from the gateway (S1110). The base station may request the channel distribution parameter from the gateway, and the gateway may transmit at least one channel distribution parameter to the base station in response to the request.

The channel distribution parameter may be a parameter for determining channel distribution information among the terminal, the relay, and the base station. The channel distribution parameter may include at least one of path loss po at a reference distance, a path loss exponent α_{UR} between the terminal and the relay, a path loss exponent α_{RG} between the relay and the base station, or a Rician factor.

The base station may receive location information of the terminal from the gateway, for example, Global Positioning System (GPS) coordinates of the terminal (S1120). The base station may determine an inter-node distance, an angle of arrival (AoA), or an angle of departure (AoD) based on the received location information of the terminal (S1130).

According to an exemplary embodiment, the base station may determine the inter-node distance, the AoA, or the AoD based on its own location information, location information of the relay, and location information of the terminal. Here, the inter-node distance may include a distance d_{UR} between the terminal and the relay or a distance d_{RG} between the relay and the base station. The AoA may include a direction of arrival of a signal from a receiver perspective, for example, a horizontal angle and a vertical angle in a direction from the relay to the base station. The AoD may include a direction of departure of a signal from a transmitter perspective, for example, a horizontal angle and a vertical angle in a direction from the base station to the relay. In addition, the AoD may include a horizontal angle and a vertical angle in a direction from the relay to the terminal.

The base station may determine an average azimuth angle and an azimuth angle variance of the base station based on the number of passive elements of the relay and the number of base station antennas (S1140). According to an exemplary embodiment, the base station may determine the average azimuth angle and the azimuth angle variance of the base station using an inertial measurement unit (IMU) such as a gyroscope or an accelerometer. Here, the base station is an aerial base station of the NTN, and the average azimuth angle of the base station may represent a direction of the base station relative to a north direction, and the azimuth angle variance may represent a degree of variation in the direction of the base station.

According to an exemplary embodiment, the base station may obtain continuous azimuth angle samples. The base station may determine the average azimuth angle by calculating an average direction in which the base station faces during a predetermined time based on the obtained azimuth angle samples. According to an exemplary embodiment, the base station may determine the azimuth angle variance based on variation of the azimuth angle of the base station from the obtained azimuth angle samples.

The base station may determine inter-node channel distribution information based on at least one of the channel distribution parameters, the inter-node distance, the AoA, the AoD, the average azimuth angle of the base station, or the azimuth angle variance of the base station (S1150). The inter-node channel distribution information may include channel distribution information between the base station and the relay and channel distribution information between the relay and the terminal.

According to an exemplary embodiment, the base station may determine path loss based on the channel distribution parameter and the inter-node distance. The base station may model distributions of AoA and AoD between nodes based on at least one of the AoA, the AoD, the average azimuth angle of the base station, or the azimuth angle variance. The base station may determine a ratio of line of sight (LOS) and non-line of sight (NLOS) signal components based on the Rician factor of the channel distribution parameter and may model a Rician channel based on the determined ratio. The base station may determine inter-node channel distribution information based on at least one of path loss, AoA and AoD distribution modeling, or Rician channel modeling.

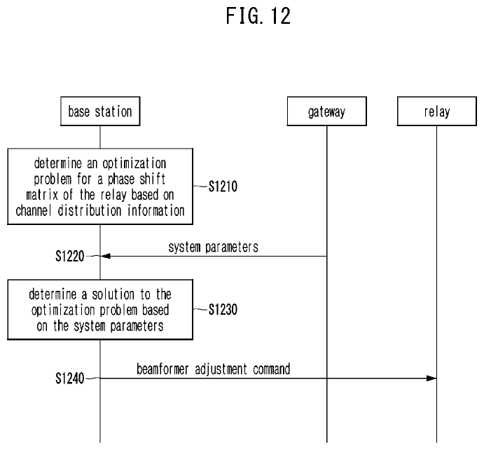

FIG. 12 is a sequence diagram illustrating an exemplary embodiment of a method in which a base station controls a beamforming operation of a relay based on channel distribution information in a non-terrestrial network.

Referring to FIG. 12, the base station may determine an optimization problem for controlling a beamforming operation of the relay or the terminal based on the channel distribution information (S1210). The base station may formulate the optimization problem as shown in Equation 8 below.

$${min}_{f , Θ} {G}_{tar} \qquad [ Equation 8 ]$$

$$s . t .$$

$$C 1 : {‖ f ‖}^{2} \leq {P}_{max}$$

$$C 2 : 0 \leq {θ}_{i} < 2 π , i = 1 , 2 , … , {N}_{R}$$

$$C 3 : Pr [ G \geq {G}_{tar} ] \geq 1 - ε$$

Here, f may indicate a transmit beamforming vector of the terminal, Θ may indicate a reflection coefficient matrix (or vector) of the relay, C1 may indicate a constraint for limiting power consumption of a transmit beamformer of the terminal, C2 may indicate a phase constraint among reflection coefficients of the relay, C3 may indicate an outage probability constraint, and ε may indicate a maximum allowable outage probability.

The base station may receive system parameters from the gateway to solve the optimization problem described above (S1220). The system parameters may include at least one parameter required for solving the optimization problem. The system parameters may include at least one of maximum transmit power Pₘₐₓ or allowable outage probability ε.

The base station may obtain a solution to the optimization problem of Equation 8 based on the system parameters received from the gateway (S1230). The base station may generate a beamformer adjustment command for controlling a beamforming operation of the relay based on the solution of the optimization problem. The base station may transmit the relay beamformer adjustment command to the relay (S1240). According to an exemplary embodiment, the base station may generate a beamformer adjustment command for controlling a beamforming operation of the terminal based on the solution of the optimization problem, and may transmit the beamformer adjustment command to the terminal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, the method comprising:
configuring a communication performance package (CPP) including at least one performance metric;
transmitting the CPP to a terminal;
receiving, from the terminal, a CPP report including measurement results for the at least one performance metric;
determining whether the measurement results of the CPP report satisfy a CPP target criterion (CPPT); and
based on the measurement results not satisfying the CPPT, controlling a beamforming operation of at least one of a relay or the terminal.

2. The method of claim 1, wherein the controlling of the beamforming operation comprises:
generating a beamformer adjustment command for controlling the beamforming operation; and
transmitting the beamformer adjustment command to at least one of the relay or the terminal.

3. The method of claim 2, wherein the generating of the beamformer adjustment command comprises:
defining an optimization problem based on the at least one performance metric of the CPP; and
generating the beamformer adjustment command for adjusting at least one of a transmit beamformer of the terminal, a receive beamformer of the terminal, or reflection coefficients of the relay based on a solution to the defined optimization problem.

4. The method of claim 1, wherein the controlling of the beamforming operation comprises:
receiving, from a gateway, at least one channel distribution parameter and location information of the terminal;
determining an average azimuth angle and an azimuth angle variance of the base station;
determining channel distribution information based on at least one of: the at least one channel distribution parameter, the location information of the terminal, the average azimuth angle, or the azimuth angle variance;
defining an optimization problem based on the channel distribution information; and
generating the beamformer adjustment command for adjusting reflection coefficients of the relay based on a solution to the defined optimization problem.

5. The method of claim 4, further comprising receiving, from the gateway, at least one system parameter for obtaining the solution to the defined optimization problem.

6. The method of claim 4, wherein the determining of the channel distribution information comprises:
determining at least one of an inter-node distance, an angle of arrival (AoA), or an angle of departure (AoD) based on at least one of location information of the base station, location information of the relay, or the location information of the terminal;
determining path loss based on the inter-node distance;
modeling a distribution of AoA and AoD based on at least one of the AoA, the AoD, the average azimuth angle, or the azimuth angle variance;
modeling a Rician channel based on the at least one channel distribution parameter; and
determining the channel distribution information based on at least one of the path loss, the modeling of the AoA/AOD distribution, or the modeling of the Rician channel.

7. The method of claim 1, further comprising decreasing a CPP reporting periodicity of the terminal relative to a default reporting periodicity.

8. The method of claim 1, further comprising, based on the measurement results satisfying the CPPT, increasing the CPP reporting periodicity of the terminal relative to a default reporting periodicity.

9. The method of claim 1, wherein the configuring of the CPP comprises:
transmitting, to the terminal, a performance metric candidate group including a plurality of performance metrics;
receiving, from the terminal, a performance metric report including at least one performance metric measurable by the terminal from among the performance metric candidate group; and
configuring the CPP including at least one measurement metric, key metric, or composite metric based on the performance metric report.

10. The method of claim 1, further comprising:
determining a CPP additional metric by performing additional computation for a performance metric included in the CPP report; and
determining whether the CPP additional metric satisfies the CPPT.

11. A method of a terminal, the method comprising:
receiving, from a base station, a communication performance package (CPP) including at least one performance metric;
measuring the at least one performance metric;
transmitting, to the base station, a CPP report including measurement results for the at least one performance metric;
receiving, from the base station, a beamformer adjustment command based on the CPP report not satisfying a CPP target criterion (CPPT); and
controlling a beamforming operation of at least one of a transmit beamformer or a receive beamformer based on the beamformer adjustment command.

12. The method of claim 11, further comprising:
receiving, from the base station, a CPP reporting periodicity adjustment command; and
decreasing a CPP reporting periodicity relative to a default reporting periodicity based on the CPP reporting periodicity adjustment command.

13. The method of claim 11, further comprising:
receiving, from the base station, a CPP reporting periodicity adjustment command based on the CPP report satisfying the CPPT; and
increasing a CPP reporting periodicity relative to a default reporting periodicity based on the CPP reporting periodicity adjustment command.

14. The method of claim 11, further comprising:
receiving, from the base station, a performance metric candidate group including the at least one performance metric;
transmitting, to the base station, a performance metric report including at least one performance metric measurable by the terminal from among the performance metric candidate group; and
receiving, from the base station, the CPP including at least one measurement metric, key metric, or composite metric based on the performance metric report.

15. A base station comprising at least one processor, wherein the at least one processor causes the base station to perform:
configuring a communication performance package (CPP) including at least one performance metric;
transmitting the CPP to a terminal;
receiving, from the terminal, a CPP report including measurement results for the at least one performance metric;
determining whether the measurement results of the CPP report satisfy a CPP target criterion (CPPT);
based on the measurement results not satisfying the CPPT, generating a beamformer adjustment command for controlling a beamforming operation of at least one of a relay or the terminal; and
transmitting the beamformer adjustment command to at least one of the relay or the terminal.

16. The base station of claim 15, wherein in the generating of the beamformer adjustment command, the at least one processor further causes the base station to perform:
defining an optimization problem based on the at least one performance metric of the CPP; and
generating the beamformer adjustment command for adjusting at least one of a transmit beamformer of the terminal, a receive beamformer of the terminal, or reflection coefficients of the relay based on a solution to the defined optimization problem.

17. The base station of claim 15, wherein in the controlling of the beamforming operation, the at least one processor further causes the base station to perform:
receiving, from a gateway, at least one channel distribution parameter and location information of the terminal;
determining an average azimuth angle and an azimuth angle variance of the base station;
determining channel distribution information based on at least one of: the at least one channel distribution parameter, the location information of the terminal, the average azimuth angle, or the azimuth angle variance;
defining an optimization problem based on the channel distribution information; and
generating the beamformer adjustment command for adjusting reflection coefficients of the relay based on a solution to the defined optimization problem.

18. The base station of claim 15, wherein the at least one processor further causes the base station to perform: decreasing a CPP reporting periodicity of the terminal relative to a default reporting periodicity.

19. The base station of claim 15, wherein the at least one processor further causes the base station to perform: based on the measurement results satisfying the CPPT, increasing the CPP reporting periodicity of the terminal relative to a default reporting periodicity.

20. The base station of claim 15, wherein in the configuring of the CPP, the at least one processor further causes the base station to perform:
transmitting, to the terminal, a performance metric candidate group including a plurality of performance metrics;
receiving, from the terminal, a performance metric report including at least one performance metric measurable by the terminal from among the performance metric candidate group; and
configuring the CPP including at least one measurement metric, key metric, or composite metric based on the performance metric report.
